(19) United States
(12) Patent Application Publication
(10) Pub. No.: US 2020/0287190 A1
(43) Pub. Date: Sep. 10, 2020

(54) POROUS COMPOSITE FILM, SEPARATOR FOR BATTERY, AND METHOD OF MANUFACTURING POROUS COMPOSITE FILM

(71) Applicant: Toray Industries, Inc., Tokyo (JP)

(72) Inventors: Takayuki Taguchi, Nasushiobara (JP); Shozo Masuda, Nasushiobara (JP); Yasuki Shimizu, Nasushiobara (JP)

(21) Appl. No.: 16/651,944

(22) PCT Filed: Sep. 27, 2018
(86) PCT No.: PCT/JP2018/035947

§ 371 Date: Mar. 27, 2020

(30) Foreign Application Priority Data
Sep. 29, 2017 (JP) 2017-191839

(51) Int. Cl. H01M 2/16; H01M 2/14

(52) U.S. Cl. CPC H01M 2/1686; H01M 2/145; H01M 2/1653; H01M 2/166

(57) ABSTRACT

A porous composite film includes: a porous substrate which is a polyolefin; and a porous layer laminated on at least one surface of the porous substrate. The porous layer satisfies the following requirements a) and b): a) a value of D50 of the cross-sectional void area distribution of the porous layer is less than 0.060 μm², and a value of D90 thereof is less than 0.200 μm²; and b) a resin constituting the porous layer is a fluorine-containing resin.

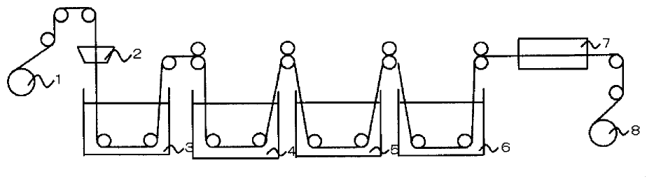

### TECHNICAL FIELD

This disclosure relates to a porous composite film, a battery separator, and a method of producing the porous composite film.

### BACKGROUND

A lithium ion secondary battery enables high performance and longtime operation of electronic equipment such as a mobile phone or a notebook computer as a high capacity battery that can be charged and discharged repeatedly. Recently, the lithium ion secondary battery is mounted as a driving battery of an environment friendly vehicle such as an electric automobile and a hybrid electric automobile, and further improvement in performance is expected. To improve the performance of the lithium ion secondary battery, studies to improve various battery characteristics such as battery miniaturization and an increase in battery capacity have been made for various materials constituting the battery. As one of them, a separator disposed between a positive electrode and a negative electrode has been studied in various ways.

For example, Japanese Patent No. 5964951 discloses a composite film including a polyolefin-based porous substrate containing a thermoplastic resin, and an adhesive porous layer provided on at least one surface of the porous substrate, and contains an adhesive resin made of a polyvinylidene fluoride resin. Japanese Patent No. 5964951 describes that it is possible to provide a non-aqueous electrolyte battery separator having excellent adhesiveness to the electrode, ion permeability, and shutdown characteristics by setting curvature of the porous substrate, an average pore size of the adhesive porous layer, and Gurley values of the porous substrate and the composite film within specific ranges.

However, since the thickness of the porous layer relative to the coating amount is increased in the battery separator of Japanese Patent No. 5964951 (that is, the density of the porous layer is small), the battery using the separator is likely to swell, and when the battery is mounted on electronic equipment such as a smart phone, electronic components may be pressed due to the swelling. In addition, when the porous layer is formed in the same thickness, the density is small. Thus, the resin or a ceramic in the porous layer, which imparts heat resistance to the separator, is reduced, and there is a possibility that sufficient heat resistance cannot be exhibited.

It could therefore be helpful to provide a porous composite film suitable for a separator of a battery having excellent heat resistance in the same thickness, small thickness of the porous layer relative to coating amount, low swelling probability, and a dense structure, and a method of producing the porous composite film.

### SUMMARY

We found that in a porous composite film including a porous substrate and a porous layer, a cross-sectional void area distribution of the porous layer is a factor that contributes for a separator which has excellent heat resistance in the same thickness, small thickness of the porous layer relative to coating amount, low swelling probability, and a dense structure.

That is, we provide a porous composite film including a porous substrate which is a polyolefin, and a porous layer laminated on at least one surface of the porous substrate in which the porous layer satisfies a) and b), wherein a) a value of D50 of a cross-sectional void area distribution of the porous layer is less than 0.060 μm², and a value of D90 thereof is less than 0.200 μm²; and b) a resin constituting the porous layer is a fluorine-containing resin. We provide a battery separator using the porous composite film. In addition, we provide a method of producing the porous composite film. The method includes: coating at least one surface of the porous substrate with a coating liquid obtained by dissolving a fluorine-containing resin in a solvent, thereby forming a coating layer; immersing the porous substrate, on which the coating layer has been formed, in a coagulating liquid containing water, and coagulating (phase separation) the fluorine-containing resin to form a porous layer, thereby obtaining a porous composite film in which the porous layer is formed on the porous substrate; flushing the porous composite film; and drying the porous composite film after flushing, in which a viscosity of the coating liquid is 600 cP or more and 1000 cP or less, a thickness of the coating layer is 5 μm or more and 25 μm or less, a temperature of the coagulating liquid is 30° C. or lower, and a concentration of the solvent in the coagulating liquid is 22% or more.

We can provide a porous composite film suitable for a separator which has excellent heat resistance in the same thickness, small thickness of the porous layer relative to coating amount, low swelling probability, and a dense structure, and a method of producing the porous composite film.

### BRIEF DESCRIPTION OF THE DRAWING

The FIGURE illustrates a method of producing the porous composite film in an example.

### REFERENCE SIGNS LIST

1: Unwinding roller
2: Dip head
3: Coagulation/flushing tank
4: Primary flushing tank
5: Secondary flushing tank
6: Tertiary flushing tank
7: Drying furnace
8: Winding roller

### DETAILED DESCRIPTION

The phrase “small thickness of the porous layer relative to coating amount, low swelling probability” means that a thickness ratio obtained by dividing the thickness of the porous layer by thickness of a coating layer is 0.13 or less, and swelling rate is 8% or less, the swelling rate being obtained by dividing the thickness of a cell using the porous composite film for a separator at the 0th cycle by the thickness of the cell at the 1000th cycle, and converting the obtained value to percent.

The porous composite film may include a polyolefin porous substrate, and a porous layer provided on at least one surface of the porous substrate, in which the porous layer contains a fluorine-containing resin, and satisfies a) and b):

a) a value of D50 of cross-sectional void area distribution of the porous layer is less than 0.060 μm², and a value of D90 thereof is less than 0.200 μm²; and
b) a resin constituting the porous layer is a fluorine-containing resin.

The porous composite film can be suitably used as a separator of a battery. For example, when the porous composite film is used as a separator of a lithium ion battery, a porous layer is preferably provided on both surfaces of the porous substrate.

Both of the porous substrate and the porous layer of the porous composite film may have voids suitable for conduction of lithium ions. Lithium ions can be conducted by holding an electrolytic solution in the voids.

### D50 and D90 of Cross-Sectional Void Area Distribution of Porous Layer

The value of D50 of the cross-sectional void area distribution of the porous layer is less than 0.060 μm² and the value of D90 thereof is less than 0.200 μm², and the value of D50 is preferably 0.053 μm² or less and the value of D90 is preferably 0.161 μm² or less, from the view point that the voids of the porous composite film are moderately mixed with fibrils, the thickness of the porous layer is small relative to the thickness of the coating layer, swelling rate of a cell is low, and the heat resistance is maintained.

When the values of D50 and D90 of the cross-sectional void area distribution of the porous layer are within the above preferred range, the size of voids of the porous layer does not become too large, and an increase in the thickness of the porous layer and the swelling of the cells can be prevented. In addition, when the thickness of the porous layer is the same, the resin or void in the porous layer exhibiting heat resistance exists densely, which improves the heat resistance. Lower limit values of the value of D50 and the value of D90 are not particularly specified, and the value of D50 is preferably 0.037 μm² or more, more preferably 0.040 μm² or more, and the value of D90 is preferably 0.053 μm² or more, more preferably 0.110 μm² or more, from the viewpoint of decrease in an injectability of an electrolytic solution due to decrease in the void size of the porous layer.

### Fluorine-Containing Resin of Porous Layer

Since the porous layer contains a fluorine-containing resin, the porous composite film having excellent injectability of an electrolytic solution can be obtained. When the porous composite film is used for the separator of the lithium ion battery, productivity of a battery can be improved.

As the fluorine-containing resin, for example, a homopolymer or a copolymer containing at least one polymerization unit selected from the group of polymerization unit species consisting of vinylidene fluoride, hexafluoropropylene, trifluoroethylene, tetrafluoroethylene, and chlorotrifluoroethylene is preferred, and a polymer (a copolymer of polyvinylidene fluoride and vinylidene fluoride) containing vinylidene fluoride units is more preferred. In particular, from the viewpoint of swelling properties with respect to the electrolytic solution, a vinylidene fluoride copolymer composed of vinylidene fluoride and another polymerization unit is preferred, and a vinylidene fluoride-hexafluoropropylene copolymer and a vinylidene fluoride-chlorotrifluoroethylene copolymer are preferred.

### Ceramic of Porous Layer

The porous composite film may include a ceramic in the porous layer. Examples of the ceramic include titanium dioxide, silica, alumina, silica-alumina composite oxide, zeolite, mica, boehmite, barium sulfate, magnesium oxide, magnesium hydroxide, and zinc oxide.

### Average Particle Diameter of Ceramic

The average particle diameter of the ceramic can be preferably set to 0.5 μm to 2.0 μm, and more preferably 0.5 μm to 1.5 μm. However, it is preferable to select the average particle diameter of the ceramic such that the upper limit of the average particle diameter of the ceramic is a thickness of the porous layer. “To” represents being equal to or more than a value described before “to” and equal to or less than a value described after “to”.

### Weight Ratio of Ceramic in Porous Layer

The content of the ceramic is preferably 50% by weight to 90% by weight, and more preferably 60% by weight to 80% by weight based on the total weight of the fluorine-containing resin and the ceramic.

### Average Area A1 of Cross-Sectional Void of Porous Layer

In the porous composite film, an upper limit value of an average area A1 of the cross-sectional void, which relates to an average value of a void diameter of the porous layer, is preferably 0.040 μm² or less, from the viewpoint of reducing swelling rate of the battery. The lower limit is not particularly specified, but the average area A1 of the cross-sectional void of the porous layer is preferably 0.026 μm² or more, and more preferably 0.031 μm² or more, from the viewpoint of injectability of the electrolytic solution.

### Thickness of Porous Layer

The thickness of the porous layer of the porous composite film can be preferably set to 1 μm to 5 μm, more preferably 1 μm to 4 μm, and still more preferably 1 μm to 3 μm. By setting the thickness of the porous layer in such a range, it is possible to obtain effects of forming a sufficient porous layer and a battery having low battery swelling rate and excellent heat resistance with a minimum thickness required.

### Thickness of Porous Composite Film

The thickness of the porous composite film can be preferably set to 4 μm to 30 μm, and more preferably 4 μm to 24 μm. By setting the thickness in such a range, it is possible to ensure mechanical strength and insulation properties with a porous layer as thin as possible.

### Porous Substrate

The porous substrate of the porous composite film is preferably a polyolefin porous film. The polyolefin resin is preferably polyethylene or polypropylene. The polyolefin resin may be a single substance or a mixture of two or more different polyolefin resins such as a mixture of polyethylene and polypropylene. In addition, the polyolefin may be a homopolymer or a copolymer. For example, the polyethylene may be a homopolymer of ethylene or a copolymer containing units of other α-olefins, and the polypropylene may be a homopolymer of propylene or a copolymer containing units of other α-olefins. The porous substrate may be a single layer film or a laminated film formed of a plurality of layers, that is, two or more layers.

The polyolefin porous film means a porous film in which a content of the polyolefin resin in the polyolefin porous film is 55 to 100 mass %. When the content of the polyolefin resin is less than 55 mass %, a sufficient shutdown function may not be obtained.

The thickness of the porous substrate is preferably 3 μm to 25 μm, and more preferably 3 μm to 20 μm. Because of such a thickness, sufficient mechanical strength and insulation properties can be obtained, and sufficient ion conductivity can be obtained.

### Method of Producing Porous Composite Film

The method of producing the porous composite film has the following characteristics.

The method of producing the porous composite film includes:

coating at least one surface of the porous substrate with a coating liquid obtained by dissolving a fluorine-containing resin in a solvent, thereby forming a coating layer;
immersing the porous substrate, on which the coating layer has been formed, in a coagulating liquid containing water, and coagulating the fluorine-containing resin to form a porous layer, thereby obtaining a porous composite film in which the porous layer is formed on the porous substrate;
flushing the porous composite film; and
drying the porous composite film after flushing,
in which a viscosity of the coating liquid is 600 cP or more and 1000 cP or less, a thickness of the coating layer is 5 μm or more and 25 μm or less, a temperature of the coagulating liquid is 30° C. or less, and a concentration of the solvent in the coagulating liquid is 22 mass % or more.

An example of the method of producing the porous composite film is described below with reference to the example in the FIGURE. In the production method, a coating liquid (varnish) is applied to (dip-coat) both surfaces of the porous substrate by using a head including a gap through which the porous substrate can pass, followed by coagulation, washing, and drying to obtain a porous composite film in which the porous layer is formed on both surfaces of the porous substrate.

First, the porous substrate unwound from an unwinding roller 1 is supplied to a dip head 2 from the above, passes through a gap under the dip head 2, is drawn out downward, and then supplied to the coagulation/flushing tank 3. The dip head 2 can accommodate a coating liquid to dip-coat both surfaces of the porous substrate passing therethrough. A coating layer is formed on both surfaces of the drawn-out porous substrate, and the thickness of the coating layer can be controlled by the size of the gap of the dip head 2, conveyance speed and the like.

As a solvent of the coating liquid, it is possible to use a good solvent capable of dissolving the fluorine-containing resin and mixing (miscible at any concentration) with a coagulating liquid (phase separation liquid) such as water. When the porous substrate coated with the coating liquid containing the good solvent and the fluorine-containing resin dissolved in the good solvent enters the coagulating liquid in the coagulation/flushing tank, the resin in the coating layer and the good solvent are phase-separated, and the resin is coagulated to form the porous layer.

Examples of the good solvent include N,N-dimethylacetamide (DMAc), N-methyl-2-pyrrolidone (NMP), hexamethylphosphoric triamide (HMPA), N,N-dimethylformamide (DMF), dimethyl sulfoxide (DMSO), and the good solvent can be selected freely depending on solubility of the resin. As the good solvent, N-methyl-2-pyrrolidone (NMP) is preferred.

The viscosity of the coating liquid can be optionally set to 600 mPa·s to 1000 mPa·s.

The viscosity of the coating liquid is measured by a B-type viscometer. A diffusion rate of the non-solvent during phase separation can be controlled by adjusting the viscosity of the coating liquid to 600 mPa·s to 1000 mPa·s such that a desired porous layer can be formed.

A concentration of the fluorine-containing resin in the coating liquid is preferably 2% by weight to 7% by weight, more preferably 3% by weight to 6% by weight.

The thickness of the coating layer can be set to 5 μm to 25 μm (one surface). Variation of the thickness of the coating layer in a width direction (direction perpendicular to a machine direction of the film) is preferably ±10% or less.

Although the dip coating method using the dip head 2 is shown in the FIGURE, various coating methods can be adopted, as long as the coating liquid having a viscosity of 600 mPa·s or more and 1000 mPa·s or less can be applied to one surface of the porous substrate such that the thickness of the coating layer is 5 μm or more and 25 μm or less and the thickness variation thereof in the width direction is ±10%. Examples thereof include a wet coating method such as common dip coating, casting, spin coating, bar coating, spraying, blade coating, slit die coating, gravure coating, reverse coating, lip directing, comma coating, screen printing, mold application, printing transfer, and ink jetting. In particular, when the coating is performed continuously and at a coating speed of, for example, 30 m/min or more, the lip directing method, the comma coating method, and the dip coating method, which are scraping methods and suitable for high viscosity, thin film, and high-speed coating, are preferred. Further, the dip coating method is more preferred in terms of forming the porous layer on both surfaces at the same time. The coating can be performed at a speed of 80 m/min or more by adopting the dip coating method.

When the coating is continuously performed, the conveyance speed can be set to, for example, 5 m/min to 100 m/min, and can be set appropriately depending on the coating method in terms of productivity and uniformity of the thickness of the coating layer.

The coagulating liquid is preferably water or an aqueous solution containing water as a main component, and it is necessary to maintain the lower limit of the concentration of the good solvent in the coagulating liquid to be 22 mass % (that is, the content of water is 78 mass % or less), preferably 24 mass % (that is, the content of water is 76 mass % or less). The upper limit of the concentration of the good solvent in the coagulating liquid is not particularly specified, and is preferably 60 mass % (that is, the content of water is 40 mass % or more), more preferably 40 mass % (that is, the content of water is 60 mass % or more), from the viewpoint of injectability of an electrolytic solution.

The porous substrate on which the coating layer has been formed by the dip head is immersed in the coagulating liquid in the coagulation/flushing tank.

The temperature of the coagulating liquid is required to be set to 30° C. or lower, preferably 28° C. or lower, more preferably 25° C. or lower. When the temperature is set within such a range, the coating layer can be phase-separated at a moderate phase separation rate in the coagulating liquid to form a desired porous layer, and temperature control is easily performed. On the other hand, the lower limit of the temperature of the coagulating liquid may be within a range where the coagulating liquid can be kept liquid (temperature higher than a freezing point), and is required to be preferably 10° C. or more in terms of temperature control and phase separation speed.

Immersion time in the coagulating liquid in the coagulation/flushing tank is preferably 3 seconds or more, and more preferably 5 seconds or more. The upper limit of the immersion time is not particularly limited, but sufficient coagulation can be achieved by immersion for 10 seconds.

The porous composite film in which the porous layer is formed on the porous substrate is obtained at a stage of being unwound from the coagulating liquid in the coagulation/flushing tank 3. The porous composite film is subsequently supplied into water of a primary flushing tank 4, sequentially introduced into water of a secondary flushing tank 5 and into water of a tertiary flushing tank 6, and continuously washed. Although the number of the flushing tanks is three in the FIGURE, the number of the flushing tanks may be increased or decreased depending on a washing effect in the flushing tank. Washing water in each tank may be continuously supplied, or the recovered washing water may be purified and recycled.

Next, the porous composite film unwound from the last tertiary flushing tank 6 is introduced into a drying furnace 7, the adhered washing liquid is removed, and the dried porous composite film is wound by a winding roller 8.

### Measurement Method

### (1) D50 and D90 of Cross-Sectional Void Area Distribution of Porous Layer

D50 and D90 of a cross-sectional void area distribution of the porous layer are determined as follows. A substrate cross section which has been cross-sectioned by ion milling in a direction perpendicular to the substrate surface is observed randomly by a scanning electron microscope (SEM) at an acceleration voltage of 2.0 kV and a magnification of 5,000 times in a direction perpendicular to the substrate cross section to obtain 50 pieces of images. Each of the obtained 50 pieces of images is cut in parallel to the surface direction of the substrate at a point where the thickness direction of the substrate is divided internally into 1:1. A gray value is acquired for the image, and for an image having a larger average value of the gray value, first, image data is read in by image analysis software HALCON (Ver. 13.0, manufactured by MVtec) and, then, after performing contour emphasis (treatment in an order of a differential filter (emphasize) and an edge emphasis filter (shock_filter)) binarization is performed. The “emphasize” of the differential filter and the “shock_filter” of the edge emphasis filter used for the contour emphasis are image processing filters contained in the HALCON. Regarding the binarization, the lower limit of a threshold with respect to the gray value is set to 64 and the upper limit is set to 255, and a part having a gray value of 64 or more is considered as a part where a fluorine-containing resin (including a filler such as ceramic when there is a filler) such as PVdF (polyvinylidene fluoride) is present. Further, a gray value of a region where the resin component and the filler are present is replaced with 255, a gray value of other regions (cross-sectional void portions) is replaced with 0, and consecutive pixels having a gray value of 0 are connected to each other, and thus areas of 100 or more cross-sectional void portions are extracted from one image. The areas of the extracted cross-sectional void portions are taken as cross-sectional void areas, and among the cross-sectional void areas, D50 and D90 in a distribution of area values of cross-sectional void areas satisfying the relationship (1) are calculated. D50 is an area where a cumulative area is 50% with respect to a total area in which the cross-sectional void areas are rearranged in an ascending order and all the areas are added together, and D90 refers to an area in which the cumulative area is 90%.

X<Xₘₐₓ×0.9 Relationship (1)

In the relationship (1), X represents each cross-sectional void area, and Xₘₐₓ represents a maximum value of each cross-sectional void area.

### (2) Average Area A1 of Cross-Sectional Void of Porous Layer

The average area A1 of the cross-sectional voids of the porous layer is measured as follows. A cross section which has been cross-sectioned by ion milling in a direction perpendicular to the substrate surface is observed randomly by a SEM at an acceleration voltage of 2.0 kV and a magnification of 5,000 times to obtain 50 pieces of cross-sectional SEM images. Each of the 50 pieces of cross-sectional SEM images is cut in parallel to the surface direction of the substrate at a point where the thickness direction of the substrate is divided internally into 1:1. A gray value is acquired for the image, and for an image having a larger average value of the gray value, first, image data is read in by image analysis software HALCON (Ver. 13.0, manufactured by MVtec) and, then, after performing contour emphasis (treatment in an order of a differential filter (emphasize) and an edge emphasis filter (shock_filter)) binarization is performed. Regarding the binarization, the lower limit of a threshold with respect to the gray value is set to 64 and the upper limit is set to 255, and a part having a gray value less than 64 is considered as a void, a part having a gray value of 64 or more is considered as a part where PVdF (including a filler when a filler is present) is present. Further, a gray value of a region where the resin component and the filler are present is replaced with 255, a gray value of other regions (void portion) is replaced with 0, and consecutive pixels having a gray value of 0 are connected to each other, and thus areas of 100 or more cross-sectional void portions are extracted from one image. The areas of the extracted cross-sectional void portions are taken as cross-sectional void areas, and among the cross-sectional void areas, an average area A1 of the cross-sectional voids for the cross-sectional void areas satisfying the relationship (1) is calculated by the relationship (2).

$$A 1 = \frac{1}{N} {\sum }_{i = 1}^{N} X i \qquad Relationship ( 2 )$$

### Lithium Ion Secondary Battery

The porous composite film can be used as a battery separator, and can be preferably used as a separator of the lithium ion secondary battery. A lithium ion secondary battery having excellent injectability of an electrolytic solution and hardly swelling can be provided by using the porous composite film as the separator.

Examples of the lithium ion secondary battery to which the porous composite film is applied include a lithium ion secondary battery having a structure in which a battery element in which the negative electrode and the positive electrode are disposed to face each other via the separator is impregnated with an electrolytic solution containing electrolytes and these are enclosed in an exterior material.

Examples of the negative electrode include a negative electrode mixture formed on a current collector, the negative electrode mixture including a negative electrode active material, a conductive assistant, and a binder. As the negative electrode active material, a material capable of doping and dedoping lithium ions is used. Specific examples thereof include a carbon material such as graphite and carbon, a silicon oxide, a silicon alloy, a tin alloy, a lithium metal, and a lithium alloy. As the conductive assistant, a carbon material such as acetylene black and Ketjen black is used. As the binder, styrene-butadiene rubber, polyvinylidene fluoride, polyimide or the like is used. As the current collector, a copper foil, a stainless steel foil, a nickel foil or the like is used.

Examples of the positive electrode include a positive electrode mixture formed on a current collector, the positive electrode mixture including a positive electrode active material, a binder, and a conductive assistant as necessary is formed on a current collector. Examples of the positive electrode active material include a lithium composite oxide containing at least one transition metal such as Mn, Fe, Co, and Ni. Specific examples thereof include lithium nickelate, lithium cobaltate, and lithium manganate. As the conductive assistant, a carbon material such as acetylene black and Ketjen black is used. As the binder, polyvinylidene fluoride or the like is used. As the current collector, an aluminum foil, a stainless steel foil or the like is used.

As the electrolytic solution, for example, a solution obtained by dissolving a lithium salt in a non-aqueous solvent may be used. Examples of the lithium salt include LiPF₆, LiBF₄, LiClO₄, and LiN(SO₂CF₃)₂. Examples of the non-aqueous solvent include propylene carbonate, ethylene carbonate, dimethyl carbonate, diethyl carbonate, ethyl methyl carbonate, and γ-butyrolactone, and a mixture of two or more of these is usually used with various additives such as vinylene carbonate. An ionic liquid (room temperature molten salt) such as an imidazolium cation liquid may also be used.

Examples of the exterior material include a metal can or an aluminum laminate pack. Examples of a shape of the battery include a coin shape, a cylindrical shape, a square shape, and a laminate shape.

### EXAMPLES

### Measurement Method

Regarding a porous composite film in each Example and each Comparative Example, D50 and D90 of a cross-sectional void area distribution of a porous layer were measured according to the above (1), and an average area A1 of cross-sectional voids of the porous layer were measured according to the above (2). In addition, basis weight, thickness, thickness of the porous layer/thickness of the coating layer, injectability of the electrolytic solution, and a swelling rate of a cell after 1000 cycles of the porous layer were measured as follows.

### Basis Weight of Porous Layer

A basis weight W_{A} of the porous layer was measured as follows by using the following formula.

W_{A}=basis weight of coated film (W_{A1})−basis weight of substrate (W_{A2})

The basis weight W_{A1} of the coated film and the basis weight W_{A2} of the substrate were measured by preparing a sample having a size of 5 cm square and were calculated using the following formula.

W_{A1}=“weight of sample of coated film having a size of 5 cm square”/0.0025
W_{A2}=“weight of sample of substrate having a size of 5 cm square”/0.0025

### Thickness of Porous Layer

The thickness t of the porous layer was measured as follows by using the following formula.

t=thickness (t₁) of porous composite film−thickness (t₂) of porous substrate

The thickness (t₁, t₂) was measured using a contact thickness gauge (“LIGHTMATIC” (registered trademark) series 318, manufactured by Mitutoyo Corporation). In the measurement, 20 points were measured at a load of 0.01 N using a carbide spherical surface measuring element ϕ9.5 mm, and an average value of the obtained measurement values was used as the thickness.

### Thickness of Porous Layer/Thickness of Coating Layer

A ratio of the thickness of porous layer/thickness of coating layer was determined by dividing the thickness t of the porous layer by the thickness t_{w} of the coating layer.

Thickness of porous layer/thickness of coating layer=t/t_{w},

### Injectability of Electrolytic Solution

0.5 μl of polypropylene carbonate (PC) as a solvent was dropped to a surface of a separator, and a spread area of the dropped liquid was evaluated after 8 minutes. At this time, the spread area of the dropped liquid was determined as “A” when 100 mm² or more, “B” when 90 mm² or more, and “C” when less than 90 mm².

Swelling Rate of Battery after 1000 Cycles

### Production of Electrolytic Solution

As an electrolytic solution, LiPF₆ (lithium hexafluorophosphate) of 1.15 mol/L and vinylene carbonate (VC) of 0.5 wt % were added to a solvent obtained by mixing ethylene carbonate (EC), methyl ethyl carbonate (MEC), and diethyl carbonate (DEC) at 3:5:2 (volume ratio of EC:MEC:DEC), thereby producing the electrolytic solution.

### Production of Positive Electrode

Acetylene black graphite and polyvinylidene fluoride were added to lithium cobaltate (LiCoO₂) and dispersed in N-methyl-2-pyrrolidone to form a slurry. The slurry was applied uniformly on both surfaces of a positive electrode current collector aluminum foil having a thickness of 20 μm and dried to form a positive electrode layer. Thereafter, a belt-shaped positive electrode in which the density of the positive electrode layer except the current collector was 3.6 g/cm³ was produced by compression molding using a roll press machine.

### Production of Negative Electrode

An aqueous solution containing 1.0 part by mass of carboxymethyl cellulose was added to 96.5 parts by mass of artificial graphite and they were mixed, and further 1.0 part by mass of styrene-butadiene latex was added as a solid content and they are mixed to form a slurry containing a negative electrode mixture. The slurry containing a negative electrode mixture was applied uniformly on both surfaces of a negative electrode current collector made of a copper foil having a thickness of 8 μm and dried to form a negative electrode layer. Thereafter, a belt-shaped negative electrode in which the density of the negative electrode layer except the current collector was 1.5 g/cm³ was produced by compression molding using a roll press machine.

### Production of Battery

The positive electrode, the porous composite film in the above Examples or Comparative Examples, and the negative electrode were laminated and, then, a flat wound type electrode body (height 2.2 mm×width 32 mm×depth 32 mm) was produced. A tab with a sealant was welded to each electrode of the flat wound type electrode body to form a positive electrode lead and a negative electrode lead.

Next, the flat wound type electrode body part was sandwiched by an aluminum laminated film, sealed by leaving some opening portions, and dried in a vacuum oven at 80° C. over 6 hours. After drying, 0.75 ml of the electrolytic solution was quickly injected, followed by sealing with a vacuum sealer, and press molding was performed at 90° C. and 0.7 MPa for 2 minutes.

Subsequently, the obtained battery was charged and discharged. As the charge and discharge conditions, constant current charge was performed at a current value of 300 mA until a battery voltage reached 4.35 V, and then constant voltage charge was performed at a battery voltage of 4.35 V until a current value reached 15 mA. After a pause of 10 minutes, the constant current discharge was performed at a current value of 300 mA until a battery voltage reached 3.0 V, and was paused for 10 minutes. Three cycles of the above charge and discharge were performed to produce a secondary battery for test (flat wound type battery cell) having a battery capacity of 300 mAh.

Charge and discharge of the flat wound type battery cell produced above were repeated for 1000 cycles by charge at 300 mA until the voltage reached 4.35 V and discharge at 300 mA until the voltage reached 3.0 V in an atmosphere of 35° C. using a charge and discharge measurement device, and an initial thickness of the cell was divided by a thickness of the cell at the 1000th cycle, and the obtained value was converted to percent, thereby determining the swelling rate of the battery.

The charge and discharge condition at this time was as follows.

Charge Conditions: 1 C, CC-CV charge, 4.35 V, 0.05 C Cut off
Pause: 10 minutes
Discharge conditions: 1 C, CC discharge, 3V Cut off
Pause: 10 minutes.

### Example 1

A porous composite film was produced according to a production process shown in the FIGURE.

Specifically, first, a polyolefin porous film (thickness: 7 μm) unwound from an unwinding roller was passed through a gap of a dip head from the above to the below of the dip head at a conveyance speed of 7 m/min, and a coating liquid was applied to both surfaces of the polyolefin porous film, followed by immersion in a coagulating liquid to form a coating layer on the polyolefin porous film. The size (length in a thickness direction) of the gap of the dip head was 45 μm. PVdF (polyvinylidene fluoride) was used as a resin of the coating liquid, NMP (N-methyl-2-pyrrolidone) was used as a good solvent that dissolves the resin, and a mass ratio of PVdF to NMP was PVdF:NMP=1:22. Alumina was used as a ceramic of the coating liquid, and a mass ratio of PVdF to alumina was PVdF:alumina=1:1.1.

In the coagulating liquid in a coagulation/flushing tank, water was used as a phase separation liquid, a concentration of NMP in the coagulating liquid was maintained at 24.9 mass %, and the temperature of the coagulating liquid set to 20° C.

At a stage of being drawn out from the coagulating liquid, the porous composite film in which a porous layer was formed on the polyolefin porous film was obtained, and the porous composite film introduced into water of a primary flushing tank, a secondary flushing tank, and a tertiary flushing tank in order, and continuously washed.

Next, the porous composite film unwound from the last tertiary flushing tank was introduced into a drying furnace, the adhered washing liquid removed, and the dried porous composite film was wound.

Production conditions and measurement results of the obtained porous composite film are shown in Table 1.

### Examples 2 to 6 and Comparative Examples 1 to 3

A porous composite film was produced in the same manner as in Example 1 except that a size (coating gap) of a gap of a dip head, a mass ratio of PVdF to alumina of a coating liquid, and a NMP concentration in the coagulating liquid were adjusted as shown in Table 1 such that a basis weight of PVdF of a porous layer was equal. Measurement results are shown in Table 1.

TABLE 1

| | NMP | | | | Porous layer | | |
|---|---|---|---|---|---|---|---|
| | concentration | PVdF:alumina | Coating gap | Thickness of coating | Thickness | Basis weight | Thickness/ |
| | [mass %] | mass ratio | [μm] | layer [μm] | [μm] | [g/m²] | thickness of coating layer |
| Example 1 | 24.9 | 1:1.1 | 41 | 21.0 | 2.0 | 2.0 | 0.095 |
| Example 2 | 24.8 | 1:2.1 | 45 | 22.9 | 2.9 | 3.2 | 0.125 |
| Example 3 | 25.1 | 1:2.6 | 39 | 19.9 | 2.4 | 3.2 | 0.120 |
| Example 4 | 40.2 | 1:1.5 | 42 | 21.3 | 2.1 | 2.4 | 0.099 |
| Example 5 | 39.5 | 1:2.4 | 41 | 21.6 | 2.6 | 3.2 | 0.118 |
| Example 6 | 39.8 | 1:3.0 | 42 | 21.4 | 2.3 | 3.8 | 0.107 |
| Comparative | 0.1 | 1:2.9 | 36 | 18.5 | 2.8 | 3.2 | 0.152 |
| Example 1 | | | | | | | |
| Comparative | 8.2 | 1:1.7 | 39 | 19.7 | 2.6 | 2.4 | 0.131 |
| Example 2 | | | | | | | |
| Comparative | 20.7 | 1:2.5 | 40 | 20.2 | 2.8 | 3.2 | 0.140 |
| Example 3 | | | | | | | |

| | D50 of cross- | D90 of cross- | | | |
|---|---|---|---|---|---|
| | sectional void | sectional void | Average area A1 of | Swelling rate of | |
| | area distribution | area distribution | cross-sectional voids | battery after 1000 | Injectability of |
| | [μm²] | [μm²] | [μm²] | cycles [%] | electrolytic solution |
| Example 1 | 0.049 | 0.156 | 0.037 | 7.50 | A |
| Example 2 | 0.052 | 0.160 | 0.039 | 7.40 | A |
| Example 3 | 0.052 | 0.158 | 0.037 | 7.30 | A |
| Example 4 | 0.042 | 0.114 | 0.032 | 6.80 | A |
| Example 5 | 0.041 | 0.116 | 0.032 | 6.80 | A |
| Example 6 | 0.040 | 0.115 | 0.033 | 6.90 | A |
| Comparative | 0.370 | 1.137 | 0.098 | 9.20 | A |
| Example 1 | | | | | |
| Comparative | 0.174 | 0.617 | 0.071 | 8.90 | A |
| Example 2 | | | | | |
| Comparative | 0.061 | 0.217 | 0.044 | 8.40 | A |
| Example 3 | | | | | |

### INDUSTRIAL APPLICABILITY

We provide a porous composite film suitable for a separator which has excellent heat resistance in the same thickness, small thickness of the porous layer relative to coating amount, low swelling probability, and a dense structure, and a method of producing the porous composite film.

Although our films, separators, batteries and methods have been described in detail with reference to specific examples, it will be apparent to those skilled in the art that various changes and modifications can be made without departing from the spirit and scope of this disclosure. This application is based on Japanese Patent Application No. 2017-191839 filed on Sep. 29, 2017, the contents of which are incorporated herein by reference.

1.-5. (canceled)

6. A porous composite film comprising:
a porous substrate which is a polyolefin; and
a porous layer laminated on at least one surface of the porous substrate,
wherein the porous layer satisfies a) and b):
a) a value of D50 of a cross-sectional void area distribution of the porous layer is less than 0.060 μm², and a value of D90 thereof is less than 0.200 μm²; and
b) a resin constituting the porous layer is a fluorine-containing resin.

7. The porous composite film according to claim 6, wherein the porous layer contains a ceramic.

8. The porous composite film according to claim 6, wherein the porous layer contains a polymer containing a vinylidene fluoride unit as the fluorine-containing resin.

9. A battery separator comprising the porous composite film according to claim 6.

10. A method of producing the porous composite film according to claim 6, the method comprising:
coating at least one surface of the porous substrate with a coating liquid obtained by dissolving a fluorine-containing resin in a solvent, thereby forming a coating layer;
immersing the porous substrate, on which the coating layer has been formed, in a coagulating liquid containing water and coagulating the fluorine-containing resin to form a porous layer, thereby obtaining a porous composite film in which the porous layer is formed on the porous substrate;
flushing the porous composite film; and
drying the porous composite film after flushing,
wherein a viscosity of the coating liquid is 600 cP or more and 1000 cP or less, a thickness of the coating layer is 5 μm or more and 25 μm or less, a temperature of the coagulating liquid is 30° C. or less, and a concentration of the solvent in the coagulating liquid is 22% or more.
